(19) United States
(12) Patent Application Publication
(10) Pub. No.: US 2011/0318532 A1
(43) Pub. Date: Dec. 29, 2011

(54) Lining Assembly on a Skin for a Tire Vulcanization Mould

(75) Inventors: Jean-Raymond Dusseaux, Enval (FR); Daniel Bonnet, Saint Georges Sur Allier (FR)

(73) Assignees: Michelin Recherche et Technique S.A., Granges-Paccot (CH); Societe De Technologie Michelin, Clermont-Ferrand (FR)

(21) Appl. No.: 13/140,757

(22) PCT Filed: Dec. 16, 2009
(86) PCT No.: PCT/FR2009/052568

§ 371 Date: Sep. 6, 2011

(30) Foreign Application Priority Data
Dec. 17, 2008 (FR) 0858708

(51) Int. Cl. B32B 3/00; B29D 30/06

(52) U.S. Cl. 428/141; 264/482

(57) ABSTRACT

The invention relates to a lining assembly (14), characterized in that it comprises:

a skin (18) having first (20) and second (22) opposed surfaces, the first surface (20) being intended to be in contact with a support block (12) of a tire mould, and

a plurality of lining elements (24) projecting from the second surface (22) of the skin (18), the lining elements being intended to form tread patterns on a portion of a radially external surface of a tire.

The invention relates to the field of tire vulcanization moulds, especially to sectorized moulds.

A sectorized mould comprises several separate parts which, when relatively close together, define a quasi-toroidal molding space. In particular, a sectorized mould comprises two lateral shells for molding the sidewalls of the tire and several peripheral sectors located between the shells for molding the tread of the tire. All the parts are brought together at an appropriate rate by an intended mechanism. The uncured blank of the future tire must be firmly applied and held in place against the mould in order to obtain precise geometric dimensions and a precise architecture and to form the tread pattern.

To form the tread patterns, the sectors of the mould comprise elements projecting from the radially internal surface of the sectors, these elements forming a negative of the patterns to be molded onto the tread of the tire.

In order for the same mould to be able to be used to manufacture tires having different forms of patterns, it is known, for example from document EP 0 523 958, for a sector of the mould to be produced from several elements: on the one hand, a support block having a generic shape defining the overall curvature of the tread of the tire and, on the other hand, a plurality of lining elements attached to the support block and intended to form the tread patterns of the tire.

Thus, to adapt a mould to the manufacture of a tire having given tread patterns, it is necessary for the various lining elements to be attached in succession to each support block of the mould sectors.

These mould adaptation operations may prove to be time-consuming and tedious. Therefore, the object of the invention is to provide a sectorized mould for the vulcanization of a tire, the manufacture and adaptation of said mould being able to be carried out simply and rapidly.

For this purpose, one subject of the invention is a lining assembly, characterized in that it comprises:
a skin having first and second opposed surfaces, the first surface being intended to be in contact with a support block of a tire mould, the thickness of the skin being between 0.25 and 3 millimetres; and
a plurality of lining elements projecting from the second surface of the skin, the lining elements being intended to form tread patterns on a portion of a radially external surface of a tire, the skin and the lining elements being produced as one piece.

By virtue of the invention, the various lining elements of the lining assembly are borne by the skin and may thus be attached in a simple operation to the support block of the mould sector, when the first surface of the skin is brought into contact with this support block.

The operation of manufacturing the mould, or that of adapting the mould to a new type of tire, is therefore simplified in relation to a mould known in the prior art since a single operation is necessary for attaching several lining elements to the support block. The positions of the lining elements relative to one another are determined by their positions on the skin of the lining assembly while it is being manufactured.

The small thickness of the skin makes the assembly relatively lightweight. It is thus possible to fix the combination of the skin and the lining elements onto the support block by adhesive bonding, without other complicated fastening means. Furthermore, the small thickness gives the combination of the skin and the lining elements flexibility, thereby making it possible to compensate for possible joining gaps between the assembly and the support block. Finally, since the assembly is made as one piece, that is to say from a single material, it is relatively strong. In particular it can withstand the forces exerted during vulcanization of the tire.

An assembly according to the invention may furthermore include one or more of the following features:
the lining assembly is produced by selective laser melting, more commonly known as laser sintering or SLM (selective laser melting). The objects are produced by selective powder melting and constructed from a superposition of layers. The advantage of this technique for manufacturing a part is that the shape of the part can be modeled by computer and the part can be easily manufactured by sintering on the basis of this modeling. Specifically, the laser can be controlled by a computer that includes a model of the part and can then manufacture the part by successive sintering of superposed powder layers. This method of manufacturing metal elements is particularly well suited to the manufacture of the lining assembly. Specifically, this method makes it possible to produce large parts of complex shapes very simply;
the shape of the first surface of the skin is complementary to that of a mould support block to which the lining assembly is intended to be attached. Thus, the lining assembly according to the invention completely covers the support block of the mould sector which is therefore not in contact with the rubber compound of the tire to be vulcanized. This makes it possible in particular to simplify the shape of the support block of the sector, which may for example be smooth in order to co-operate with the first surface of the skin of the lining assembly; and
the second surface of the skin is shaped so as to partially define the shape of the tire while it is being molded. Specifically, this second surface is intended to come into contact with the rubber compound of the tire to be vulcanized. The second surface of the skin therefore defines the smooth parts of the tire tread.

The other subject of the invention is a process for manufacturing a lining assembly, comprising:
a skin having first and second opposed surfaces, the first surface being intended to be in contact with a support block of a tire mould, the thickness of the skin being between 0.25 and 3 millimeters; and
a plurality of lining elements projecting from the second surface of the skin, the lining elements being intended to form tread patterns on a portion of a radially external surface of a tire, in which process the skin and the lining elements are produced as one piece.

Optionally, the assembly is produced by laser sintering.

The invention will be better understood while reading the following description, given solely by way of example and with reference to the drawings in which:

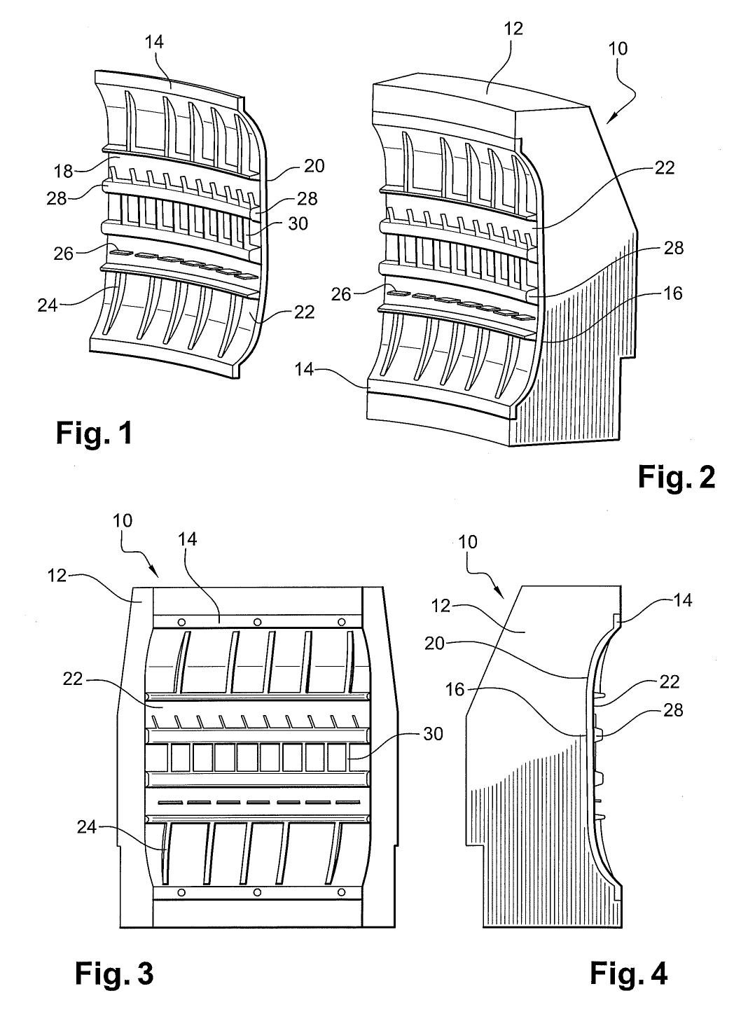

FIG. 1 is a perspective view of a lining assembly according to the invention;

FIG. 2 is a perspective view of a mould sector comprising a support block and the assembly shown in FIG. 1;

FIG. 3 is a top view of the sector shown in FIG. 2; and

FIG. 4 is a cross-sectional view of the sector shown in FIGS. 2.

FIG. 2 shows a sector, denoted by the general reference 10, of a sectorized mould (not shown) for the vulcanization of a tire.

The sector 10 comprises a support block 12 and a lining assembly 14 attached to the support block 12.

The support block is formed by a solid block of steel having in particular a support surface 16 intended to receive the lining assembly 14. The support surface 16 is substantially smooth and has a shape that substantially matches the general curvature of the tread of the tire to be molded.

The lining assembly 14 comprises a skin 18 having first 20 and second 22 opposed surfaces, the first surface 20 being intended to be in contact with the support surface 16 of the support block 12.

The skin 18 further includes a plurality of lining elements 24 projecting from the second surface 22, the lining elements 24 being intended to form the patterns of a portion of the tread of the tire to be molded.

Among the lining elements 24, the assembly 14 comprises especially lamellae 26 intended to form circumferential slots in the tire tread or circumferential beads 28 intended to form a longitudinal groove on the tire tread.

The various beads 28 are connected by axial lamellae 30 so as to form an array of lining elements 24.

The thickness of the skin 14 is between 0.25 and 3 millimetres and the various lining elements 24 are made as one with the skin 18. In other words, the lining element 14 is produced as one piece.

To produce such a lining element 14, a selective laser sintering process is carried out with a metal powder.

During manufacture of the lining assembly 14, measures are taken to ensure that the shape of the first surface 20 of the skin 18 is complementary to the shape of the support surface 16 of the support block 12 so that the skin 18 can correctly co-operate with the support block 12. However, the various lining elements 24 provided on the skin 18 may be of any shape, this being defined according to the type of tread pattern that it is desired to obtain on the tire to be molded.

Thus, it is possible to devise various types of lining assemblies 14 in which the lining elements 24 vary, it being possible for each assembly 14 to be positioned on the surface 16 of one and the same support block 12. This therefore makes it possible to be able to mould various tire types in the same mould without having to change the support blocks 12 constituting this mould.

To adapt a mould to the manufacture of a new tire type, all that is required is to remove the lining assemblies 14 from the support blocks 12, corresponding to the old type of tire manufacture, and then attach, in a single operation, the new lining assemblies 14 on the surface 16 of the support block 12.

Because the various lining elements 24 are on one and the same skin 18, it is possible to attach all the lining elements of the same sector to a support block 12 in a single operation, this being particularly rapid.

The invention has been described in relation to a sectorized mould. However, it may also be implemented in relation to a mould of another type.

1. Lining assembly comprising:
a skin having first and second opposed surfaces, the first surface suitable to be in contact with a support block of a tire mould, the thickness of the skin being between 0.25 and 3 millimeters; and
a plurality of lining elements projecting from the second surface of the skin, the lining elements being suitable to form tread patterns on a portion of a radially external surface of a tire,
the skin and the lining elements being produced as one piece.

2. Assembly according to claim 1, produced by laser sintering.

3. Assembly according to claim 1, in which the shape of the first surface of the skin is complementary to that of a mould support block to which the lining assembly is intended to be attached.

4. Assembly according to claim 1, in which the second surface of the skin is shaped so as to partially define the shape of the tire while it is being molded.

5. Process for manufacturing a lining assembly, comprising:
a skin having first and second opposed surfaces, the first surface suitable to be in contact with a support block of a tire mould, the thickness of the skin being between 0.25 and 3 millimeters; and
a plurality of lining elements projecting from the second surface of the skin, the lining elements suitable to form tread patterns on a portion of a radially external surface of a tire,
comprising producing the skin and the lining elements are produced as one piece.

6. Process according to the preceding claim, in which the assembly is produced by laser sintering.
